(19) United States
(12) Patent Application Publication
(10) Pub. No.: US 2024/0352984 A1
(43) Pub. Date: Oct. 24, 2024

(54) WORKPIECE TO BE COATED WITH A REFINEMENT LAYER, AND MEASURING METHOD FOR A WORKPIECE

(71) Applicant: HPL TECHNOLOGIES GMBH, Aachen (DE)

(72) Inventor: Tobias Phillip UTSCH, Wetzlar (DE)

(73) Assignee: HPL TECHNOLOGIES GMBH, Aachen (DE)

(21) Appl. No.: 18/683,686

(22) PCT Filed: Aug. 16, 2022
(86) PCT No.: PCT/DE2022/100604

§ 371 Date: Feb. 14, 2024

(30) Foreign Application Priority Data
Aug. 16, 2021 (DE) 10 2021 208 965.8

(51) Int. Cl. F16D 65/12; F16D 69/04

(52) U.S. Cl. CPC F16D 65/127; F16D 69/04; F16D 2069/0491; F16D 2250/0046

(57) ABSTRACT

The invention relates to a workpiece to be coated with a finishing layer. The workpiece has a support body with a treatment surface, wherein the finishing layer is applied or can be applied onto the treatment surface. The workpiece is primarily characterized in that the workpiece is provided with a reference mark to which a stationary coordinate system that is highly precise relative to the workpiece can be repeatedly assigned. By virtue of the aforementioned workpiece and the corresponding reference mark, a finishing layer can be applied onto the workpiece in a highly precise manner, and the finishing layer can be reprocessed.

The invention relates to a workpiece to be coated with a refinement layer, a measuring-in method for a workpiece, a coating method for such a workpiece, and a reprocessing method for such a workpiece with a worn refinement layer.

In addition to the exhaust gas pollution from internal combustion engines in motor vehicles, the abrasion of tires and brakes is becoming increasingly important when it comes to complying with fine dust limit values, especially in cities. During the actual braking process on a brake disc, kinetic energy from propulsion is mainly dissipated into thermal energy due to friction between the brake pad of the brake calliper and the friction surface of the brake disc. During the friction process, in some load conditions, part of the material on the friction surface is removed and thus enters the environment as fine dust. The brake discs are often made from a support body made of grey cast iron or centrifugally cast. The support body is susceptible to weathering and tends to corrode quickly. In motor vehicles, particular attention must be paid to the use of salts to combat slippery ice, which exposes the support body to an aggressive salt solution. As a result of abrasion and corrosion, the longevity of such a brake is limited, which results in further environmental pollution due to the need for premature replacement. In addition, the support body usually has insufficient friction hardness for a controlled braking process. The disadvantages of the material of the support body can be at least partially solved by means of a refinement layer, with which increased friction hardness (on the friction surface) and/or increased corrosion resistance can be achieved. Additional material leads to increased mass. An increased mass is reflected not only in the production price of the brake disc, but also in fuel requirements over its service life and thus in increased exhaust emissions. It is therefore desirable to use as little material as possible for the refinement layer.

Proceeding from this, the present invention is based on the object of at least partially overcoming the disadvantages known from the state of the art. The features according to the invention result from the independent claims, to which advantageous embodiments are shown in the dependent claims. The features of the claims can be combined in any technically sensible manner, wherein the explanations from the following description and features from the figures, which comprise additional embodiments of the invention, can also be consulted.

The invention relates to a workpiece to be coated with a refinement layer, wherein the workpiece has a support body with a treatment surface, wherein the refinement layer is applicable or is applied onto the treatment surface.

The workpiece is primarily characterised in that the workpiece is provided with a reference mark to which a stationary coordinate system that is highly precise relative to the workpiece is repeatably assignable.

In the following, reference is made to the axis of rotation mentioned if the axial direction, radial direction or the rotational direction and corresponding terms are used without explicitly stating otherwise. Ordinal numbers used in the preceding and following descriptions, unless explicitly stated to the contrary, only serve to clearly distinguish them and do not reflect the order or ranking of the designated components. An ordinal number greater than one does not mean that another such component must necessarily be present.

A workpiece is proposed here, which is equipped as a support body with a treatment surface to be coated with a refinement layer. The refinement layer is an applied layer which is designed to increase the friction hardness and/or to protect the support body from corrosion. A refinement layer includes, for example, metals, metallic compounds, oxides, nitrides and/or carbides, which increase the friction hardness and/or corrosion protection.

In an embodiment, the support body is a torque-receiving component. In another embodiment, the workpiece is a component of a device in an aggressive environment, for example a hydraulic piston in an external environment or a turbine blade in a hot and (aggressive) fuel-filled environment. The workpiece or the support body is designed to absorb mechanical and thermal loads and is designed accordingly. The support body is made, for example, from a metallic alloy. In an embodiment, the support body is made in several parts, for example made of pressed and/or riveted sheets. In an alternative embodiment, the support body is originally formed from lamellae Gray cast iron or centrifugal cast and/or formed as an integral part. The support body comprises a treatment surface which is equipped to receive the refinement layer or to which the refinement layer has already been applied.

During the process of coating the treatment surface with the refinement layer, there is (within limits) at least some uncertainty (tolerance up to rejection) regarding the amount and distribution of material applied. Furthermore, there is uncertainty regarding the quality of the treatment surface, that is the roughness, flatness, waviness and inclination of the surface (for example so-called shielding on a brake disc). Furthermore, there is uncertainty regarding the clamping of the workpiece in the tool chuck of the treatment device, that is the relative position to a coating unit. In addition, (for example due to the thermal input during coating) (new) deformations can occur on the workpiece during the coating process.

Until now, such effects were priced in as tolerances and compensated for through appropriate preparation (turning with a narrow tolerance), (increased) layer thickness of the refinement layer and post-processing (abrasion of a lot of excess material).

It is now proposed to provide a reference mark on the workpiece. The reference mark is arranged on the workpiece in such a way that a stationary coordinate system that is highly precise is assignable onto the workpiece by means of the reference mark. In an embodiment, the reference mark is designed in such a way that the information on individual properties of the workpiece or the treatment surface can be found in a repeatable manner (preferably by machine), or measured data can be localized on the workpiece even after re-clamping. For example, in an independent quality testing step (for example after a transport route on a conveyor belt) it is possible to check at least randomly or 100% whether the desired quality of the brake disc or the refinement layer has been achieved. Such a test can be carried out non-destructively and based on the measured data.

It should be noted that the reference mark is equipped for a stationary coordinate system that is highly precise. This means that a determination of a coordinate on the workpiece (at least in the region of the treatment surface) is accurate to less than 1 mm [one millimetre], preferably less than 250 um, in the plane and less than 10 μm [ten microns], preferably less than 2 μm assignable repeatably. With such a high level of precision, errors or irregularities in the refinement layer that are relevant for cost-efficient production can be reliably localized.

A suitable measurement unit uses, for example, a laser triangulation method (for example using laser profilometry or laser scanning) or ultrasonic measurements. In some circumstances, a tactile measurement is sufficient. In an embodiment, the area measurement is carried out tactilely and the height measurement is carried out optically.

In an embodiment, the reference mark is a feature arranged on the outside, for example on the outer edge and/or on the lightly loaded components of the workpiece. Assuming a (sufficiently) rigid workpiece, the coordinate system is then determinable in comparison to (new) measurement results. In an embodiment, the reference mark is a measurable marking (for example in the manner of a crosshair), so that measured data clearly relates to the reference mark itself. A measuring is therefore not necessary. Assuming that the (unique) reference mark is in an unchangeable location (for example at the location relevant for assembly), any possible deformation of the workpiece is determinable by (new) measuring in comparison to the reference mark itself and/or in comparison to the (saved) measuring data from a previous measuring-in method. In an embodiment, the reference mark itself is subjected to a (possible) deformation (for example as a predetermined cross) and is arranged in a region of the workpiece that is stressed during operation or during production. The deformation of the reference mark (for example the cross) can then be determined and conclusions can therefore be drawn about a deformation in the region of the reference mark. In an embodiment, two or all embodiments are combined with one another, optionally redundantly, for increased security of the measurement and/or increased precision of the measurement.

The reference mark is useable to specifically approach a measurement unit to the workpiece. For example, a stored model of the workpiece with the refinement layer is stored in the measurement unit, wherein the layer thickness or the layer thicknesses of individual layers of the refinement layer (formed one after the other and/or with different materials) are preferably depicted within the model. The workpiece or the reference mark preferably also includes an identification mark, which allows the workpiece to be assigned to a stored model. The model is, for example, a point cloud consisting of individual measured, empirically or mathematically corrected and/or extrapolated measurement points.

It is further proposed in an advantageous embodiment of the workpiece that the workpiece is a rotational workpiece with an axis of rotation, preferably a brake disc for a motor vehicle.

The workpiece is designed to be rotationally symmetrical as a rotational workpiece, wherein the rotational workpiece is designed around an axis of rotation. The mechanical and thermal loads on the workpiece can be easily absorbed or dissipated due to the rotational symmetry, so that mechanical overload or a temperature peak within the workpiece can be ruled out. In an embodiment, the workpiece is designed as a hydraulic piston with a refinement layer, so that the refinement layer can easily withstand the mechanical and chemical stress due to the oily environment and the mechanical load.

In a preferred embodiment, the workpiece is designed as a (rotationally symmetrical) brake disc for a motor vehicle. The brake disc is exposed to high mechanical (friction) and thermal loads during operation in a motor vehicle and is designed in accordance with the description above. The brake disc is firmly connected to a wheel hub of a vehicle wheel and can therefore be decelerated by a brake calliper attached to the vehicle frame by means of its brake pads by means of friction on the brake disc or part of the brake disc of the workpiece. The refinement layer is designed in such a way that corrosion is prevented and abrasion is reduced.

Here, for example, the support body is designed radially outward in such a way that it includes a chamfer on an outer edge of the brake disc. In the region of the chamfer, that is in the region of the treatment surface that is inclined axially inwards, the refinement layer is applied in such a way that it projects horizontally beyond the chamfer in a radially outward direction and only follows the chamfer to a limited extent. It should be noted that the refinement layer does not protrude beyond the outer edge of the brake disc, but rather only continues the horizontal portion of the treatment surface further horizontally radially outwards.

It is further proposed in an advantageous embodiment of the workpiece that the refinement layer is a hard material layer for a friction surface of the workpiece.

In order to withstand the high mechanical (friction) and thermal loads that occur on the workpiece during operation, it is proposed here that the refinement layer is formed from a hard material layer. The hard material layer is a layer made up of formations of intermetallic phases (preferably carbides, most preferably niobium [Nb], silicon [Si], chromium [Cr], tungsten [W] and/or titanium [Ti]), wherein a friction surface is created by means of the hard material layer is formed on the workpiece. By means of the hard material layer an increased hardness in the region of the friction surface can be provided. In a preferred embodiment, an increase in hardness by a factor of 5, for example, is achieved compared to the metallic alloy that forms the support body.

In the embodiment, the friction surface is equipped as a brake disc to absorb torque or to dissipate kinetic energy in interaction with a brake pad. A friction pair is formed by means of the friction surface and the brake pad. When operating as a brake, a high level of hardness in the region of the friction surface is advantageous because it reduces abrasion (and thus fine dust) and increases the service life.

It should be noted that with an exact measurement of the refinement layer and, if applicable, the treatment surface in advance of the coating method, the amount of coating material and, if necessary, the number of individual layers can be reduced. The fact that a reliable refinement layer is still generated is provable independently of customer tests on endurance test stands and/or destructive testing, for example by a customer using the reference mark as a reference to at least measure the surface of the refinement layer and compare it with the stored data. In a destructive test, a cut surface to be tested (for example microscopically) can be formed at a particularly critical point (for example close to a tolerance limit of the layer thickness or layer composition) by forming the cut based on the reference mark as a reference.

Another aspect is that, under certain circumstances, manufacturing precision can be increased or reduced in the preparation of the treatment surface because in the first case an even thinner coating is then possible or in the second case the tolerances are due to a required layer thickness in conjunction with a permissible tolerance of the layer thickness are equalizable.

Further, it is proposed in an advantageous embodiment of the workpiece that the reference mark is retained over an intended service life of the workpiece, wherein the reference mark is preferably still retained when the workpiece or the refinement layer is reprocessed.

Each workpiece has a predetermined or maximum service life due to the mechanical and thermal loads that prevail during operation. The workpiece must therefore be replaced after the predetermined service life, for example a brake disc in order to ensure the braking performance (that is the coefficient of friction in the friction pair) during operation. Furthermore, this maximum service life is (usually empirically) specified by the manufacturer or by law and in a high percentage of cases the brake disc could still be used at this point. The reference mark allows measurement data to be created and compared with the stored measurement data (at least for the most critical points) and thus to be able to determine (at least with a high degree of certainty) whether there is maximum wear or whether a relevant service life still remains available. This means that significant costs can be saved (for example in a flat-rate maintenance contract as is usual with leasing) and, last but not least, environmental costs can be reduced.

In a preferred embodiment, the reference mark is arranged in such a way that the reference mark is still retained when the workpiece and/or the refinement layer is reprocessed. For example, in a reprocessing method, the refinement layer is removed so that a new refinement layer is applicable; because the support body is then usually still undamaged or at least sufficiently intact or can be repaired with little effort. The support body can therefore still be reused even if the refinement layer is marginally worn out or worn. It is therefore possible to reprocess the workpiece.

In order to measure deformation or removal of a remaining refinement layer and/or the support body, which may occur during operation during the (first) service life, it is proposed here that the reference mark is retained over a (first) intended service life. The reference mark is arranged on the workpiece in such a way that it is still useable during operation to reference the current state of the refinement layer or the treatment surface or another relevant part of the support body.

In an embodiment, an (irreversible) deformation of the workpiece has occurred due to high thermal loads on the workpiece, so that this deformation is taken into account when reprocessing the refinement layer. For example, during reprocessing, the old (partly still preserved) refinement layer is removed so that the support body is not removed or only removed to a minimal extent. The information for the comparison in order to be able to detect the (possible) deformation is clearly referenceable to the previous or original shape of the workpiece using the reference mark.

It is further proposed in an advantageous embodiment of the workpiece that the workpiece is a brake disc and the reference mark is arranged on at least one of the following sections of the brake disc:
in the gooseneck region;
in the region of the ventilation ribs between the two friction discs of the brake disk in an internally cooled embodiment, preferably radially on the outside;
on the outer edge of the brake disc;
on the wheel hub radially outside or radially inside on the shell side, axially inside or axially outside on the front side;
in the treatment surface; and
in or as a balancing mark.

It is now proposed here that with the workpiece as a brake disc of a disc brake, in the region of motor vehicles usually with internal cooling, the reference mark is arranged in an easily readable and permanently readable manner. In a brake disc with internal cooling, two friction discs are connected to one another with radial ventilation ribs at an axial distance from one another, so that waste heat is removeable efficiently by means of intrinsic forced convection. Furthermore, most brake discs in motor vehicles have a so-called gooseneck extending radially inwards to the wheel hub, by means of which the wheel hub flange is connected to the friction disc or discs.

In an embodiment, the reference mark is arranged in the region of the gooseneck, so that the reference mark is not or not completely in contact with the refinement layer. This prevents the reference mark from being removed during operation of the brake disc, as no brake pad is applied in the region of the gooseneck and no brake friction is generated.

Alternatively or additionally, the reference mark (in the case of an internally cooled disc brake) is arranged in the region of the ventilation ribs between the two friction discs. The reference mark is preferably arranged on the radial outside. For example, in extreme high-speed laser deposition welding [EHLA], the deposition laser beam is directed perpendicularly or at a slight angle of inclination to a surface normal onto the brake disc clamped in the tool chuck, and the refinement layer is thus applied to the treatment surface. The measurement unit for determining deformations and/or fluctuations in the layer thickness of the refinement layer is arranged in the line of sight of the ventilation ribs with the measurement unit, and thus the reference mark is arranged in a straight line of sight from the radial outside. This enables detection during application or removal.

Alternatively or additionally, the reference mark is arranged on the outer edge of the brake disc. The outer edge here refers to the surface with a radially aligned surface normal. In an alternative embodiment, the outer edge also includes a chamfer with a surface normal at an angle to the axial direction, wherein preferably no or no refinement layer that is directly loaded during operation is applied here.

Alternatively or additionally, the reference mark is arranged on the wheel hub radially outside or radially inside on the shell side, axially inside or axially outside on the front side. Abrasion during operation is also excluded here because the brake pad is not in contact with the brake disc. In the case of a front-side arrangement, a joining joint (gap) is preferably formed, wherein this surface is well protected against corrosion due to the sealing effect of this gap against splash water.

Alternatively or additionally, the reference mark is designed such that it has a corresponding depth that extends beyond the layer thickness of the refinement layer. For example, the reference mark is arranged with a cutting tool in the treatment surface, that is below the refinement layer, so that the reference mark only becomes visible (again) when the refinement layer is removed or (especially if the measurement unit is arranged perpendicular to the treatment surface) the reference mark is also formed by the refinement layer and thus remains visible.

Alternatively or additionally, the reference mark is arranged in a balancing mark or integrated into it or designed as a balancing mark. When balancing an imbalance, balancing marks are introduced into the material (the support body) of the brake disc, for example milled. This is often carried out before the coating method, so that in this embodiment the reference mark is already introduced before the coating method begins.

It should be noted that a plurality of reference marks are arrangeable on the brake disc, so that a combination of two or more embodiments can be implemented. In a preferred embodiment, a plurality of reference marks are arranged on the brake disc, wherein the plurality enables precise (or more precise compared to a single reference mark) metrological detection of deviations of the brake disc from the target brake disc.

It should be noted that with a reference mark that is visible or measurable during coating, a change in position of the reference mark is also useable as information about a deformation of the workpiece, provided the assumption is sufficiently correct that the relative position to the tool chuck is constant. Together with empirical data and/or other measurement data, the deformation of the workpiece can then be concluded. For example, an axial change in position of the reference mark on the outer edge of a brake disc during thermal coating is a (possibly sufficient) indication of (reinforcement of) shielding of the treatment surface.

According to a further aspect, a measuring-in method for a workpiece is proposed, comprising the following steps:

a. Clamping in a tool chuck, a workpiece with a treatment surface to be coated with a refinement layer;

b. Imprinting into the workpiece and detecting a reference mark and referencing the reference mark to the tool chuck; and

c. after step a., by means of a measurement unit, measuring the workpiece referenced to the reference mark.

For the above-mentioned object, a measuring-in method is proposed here, in which a reference mark is arranged on the workpiece in such a way that a predetermined measurement of the workpiece can be carried out using a measurement unit. For the sake of clarity, without excluding the general public, reference is made to the above description of the method with reference to the workpiece described there with a treatment surface to be coated.

It is suggested here that in step a. the workpiece is clamped in a tool chuck. In addition, the workpiece is equipped to be coated the treatment surface. For example, the treatment surface is prepared using sandblasting and/or carbide blasting in such a way that a refinement layer adheres well to the treatment surface. The tool chuck is a clamping device for a reliable, permanent position of the workpiece in the measuring device or a coating device, in which coating can also be carried out in addition to measuring.

In an embodiment, after step a. the reference mark is detected in step b. In an embodiment, the reference mark has already been placed on the workpiece in a previous step and is now detected in step b. In an alternative embodiment, the (overall) step b. before step a. carried out or in a sub-step b1. the reference mark is introduced and in a sub-step b2. simultaneously with step a. the reference mark is detected, and preferably used for exact alignment of the workpiece in the tool chuck.

For example, the reference mark is introduced into the workpiece using a cutting tool or, alternatively or additionally, a reference mark is applied additively to the workpiece, for example by means of deposition welding.

It should be noted that in both embodiments the reference mark is referenced to the tool chuck, wherein the tool chuck comprises an external (machine) coordinate system. The tool chuck and the reference mark arranged on it are therefore useable for repeatable referencing of the workpiece on a measurement unit. In an embodiment, recording the reference mark is a static recording for referencing the workpiece to the tool chuck that is in the machine coordinate system). In another embodiment, the reference mark and therefore its position is permanently repeated in a machining process (for example during turning, coating and/or grinding, for example a brake disc), for example every time it passes a specific measuring sensor, and thus a dynamic change in position and thus a deformation of the workpiece is detected. Due to the temporal resolution of the dynamic detection, the cause is known (empirically) and a complex deformation is determinable with little measurement effort, for example the so-called shielding of a brake disc.

After step a., in step c., the workpiece is measured using a measurement unit. The reference mark is (also) used as a reference so that the measurement data is referenced to a stationary coordinate system of the workpiece that is highly precise. Recorded measurement data is (intrinsically) initially referenced to the measuring device that is to the machine coordinate system). Because the position of the reference mark in relation to the machine coordinate system is known, these measurement data is referenceable to the workpiece.

It should be noted that the order of steps b. and c. is interchangeable at will. For example, it is advantageous to first measure the workpiece and then determine where a suitable location for a reference mark is. Alternatively or additionally, it is advantageous for a process flow to carry out the sequence of steps accordingly. However, the workpiece must not be removed from the tool chuck until the measurement data has been referenced to the reference mark.

In a subsequent method according to step b. or c. the workpiece is prepared for coating. For example, the treatment surface is cleaned and/or roughened so that the refinement layer is applied. The measuring-in method and the coating method (with or without re-clamping) are preferably carried out on the same machine tool.

According to a further aspect, a coating method for a workpiece according to an embodiment according to the above description is proposed, having the following steps in the order mentioned:

1.) Clamping in a tool chuck, a workpiece with a treatment surface for coating with a refinement layer;

2.) Detecting the reference mark, wherein preferably the reference mark is generated in a measuring-in method according to an embodiment according to the above description, and referencing the reference mark to the tool chuck; and

3.) Applying a refinement layer to the treatment surface of the workpiece referenced the reference mark detected in step 2.),

wherein preferably the reference mark is permanently detected during step 3.) and a change in position of the reference mark relative to the tool chuck is monitored.

A coating method is now proposed here, wherein a workpiece is coated with a refinement layer. For the sake of clarity, without excluding the general public, reference is made to the above description of the method with reference to the workpiece described there with a treatment surface to be coated.

In step 1.), the workpiece is clamped in a tool chuck in such a way that the treatment surface of the workpiece can be coated with a refinement layer in a later step. For example, the workpiece is clamped in such a way that coating from several spatial directions is possible. As a result of, for example, complex geometries of the workpiece, it is often necessary to machine the workpiece all around. The treatment surface of the workpiece has been prepared in a previous step in such a way that a predetermined surface quality is provided.

In a subsequent step 2.), the reference mark is detected and referenced to the tool chuck. When referencing, the external (machine) coordinate system of the tool chuck is designed in a way allowing the same measurement result to be displayed each time a plurality of workpieces are detected and/or during a repeated coating method on the same workpiece. To detect the reference mark, a (for example optical) measurement sensor is provided, preferably a plurality of (for example optical) measurement sensors, so that the reference mark is detected during the coating method.

In an embodiment, the reference mark is first generated in step 2.) and is then or will then be referenced with the tool chuck. For example, the reference mark is generated using a cutting tool during step 2.), so that it is then detected subsequently or at the same time. It should be noted that a cutting tool is equipped, for example, for machining, laser beam machining and/or water jet machining.

In a preferred embodiment, the reference mark is generated using a measuring-in method. For the sake of clarity, reference is made to the above description of the measuring-in method without excluding the general public. At the same time as the reference mark is detected, it is referenced to the tool chuck so that repeatable measurement results are providable.

In a subsequent step 3.), a refinement layer is applied to the treatment surface of the workpiece or the support body, wherein the application is referenced to the reference mark. Due to the referencing by means of the reference mark, which was detected in step 2.), and the tool chuck, the application takes place in a repeatable predetermined geometry, so that the refinement layer is applied to the treatment surface in a uniform and targeted manner in step 3.).

In an embodiment, a coating material of the refinement layer is applied to the treatment surface using high-velocity flame spraying [HVOF]. In an embodiment, the coating material of the refinement layer is provided as a wire and applied using arc-wire deposition welding. Alternatively, the coating material is provided as a powder and applied using arc powder deposition welding. The coating material is melted using an electric arc and the melt is then applied to the treatment surface, so that a coating or the refinement layer is formed. In an embodiment, extremely high speed laser deposition welding [EHLA] is used with a powdered material supply and a deposition laser focused above the treatment surface. In an embodiment, several methods are combined with one another.

It should be noted that in both embodiments the refinement layer is applied by referencing the reference mark to the tool chuck.

In a preferred embodiment, the reference mark is permanently detected during step 3.), so that a change in position of the reference mark relative to the tool chuck is monitored over the time of application. When applying the refinement layer, any application errors are monitored by detecting the reference mark, most preferably a plurality of reference marks, so that due to the change in the spatial arrangement of the reference mark relative to the tool chuck, the application errors are monitored and preferably corrected during the ongoing process. The plurality of sensors set up to detect the reference mark in step 2.) are equipped in such a way that a 2.5-dimensional model and/or 3-dimensional model of the reference mark or (in reference to the tool chuck) of the workpiece can be detected. By detecting the reference mark or changing it during application, there is increased accuracy when applying the refinement layer to the treatment surface and/or permanent referencing of the measured information about the workpiece.

It should be noted that the coating method can also be used analogously for a turning method and/or a grinding method or other processing of workpieces. Then step 3.) is to be replaced accordingly by the application of a refinement layer on the treatment surface (of the workpiece referenced to the reference mark detected in step 2.) by turning off or grinding off material from the treatment surface (of the workpiece referenced to the reference mark detected in step 2.).

According to a further aspect, a reprocessing method for a workpiece having a worn refinement layer according to an embodiment according to the above description is proposed, comprising the following steps in the order mentioned:

i. Clamping of a workpiece with a worn refinement layer in a tool chuck, wherein preferably the now worn refinement layer has been produced by means of a coating method according to an embodiment according to the above description;

ii. Detecting the reference mark, wherein preferably the reference mark is generated in a measuring-in method according to an embodiment according to the above description before or at the time of generation of the now worn refinement layer, and referencing the reference mark to the tool chuck; and

iii. Removal of the worn refinement layer and preparation of the treatment surface;

iv. Applying a new refinement layer on top of the one in step iii. The prepared treatment surface of the workpiece is referenced to that in step ii. detected reference mark.

In the following, reference is made to the refinement layer, the coating method and the measuring-in method without exclusion of the general public and reference is made to the respective description above. Due to the corrosion resistance of the refinement layer, the supporting body of the workpiece is protected from weathering, so that a reprocessing method is proposed here in the interests of sustainability and to save costs. Using the reprocessing method, a worn refinement layer is removable and a new refinement layer is applicable to the treatment surface of the workpiece.

In one step i. the workpiece is clamped in a tool chuck, wherein the workpiece comprises a worn refinement layer. In an embodiment, the worn refinement layer is a conventional refinement layer, which is designed as a component of a purchased workpiece.

In a preferred embodiment, the now worn refinement layer has been applied to the treatment surface of the workpiece using the coating method according to the above description. For example, the refinement layer has reached or already exceeded its predetermined service life, so that the minimum layer thickness of the refinement layer has been reached and/or fallen below.

In a subsequent step ii., the reference mark, which was created before or at the time of creation of the now worn refinement layer, is detected and referenced to the tool chuck. In an embodiment, the reference mark is only used in step ii. of the reprocessing method. For example, a conventional workpiece with a refinement layer is designed in such a way that the workpiece is free of a reference mark, so that this is used in step ii. of the reprocessing method.

In a preferred embodiment, the reference mark was generated before or at the time of producing the refinement layer in the measuring-in method, for example in step b. of the measuring-in method described above. In this embodiment, a more precise measurement of the worn refinement layer can be carried out by means of the reference mark, which was set before or at the time of creation of the refinement layer, so that in a later step iii. the removal can be carried out in a targeted manner, that is, less waste can be achieved on the support body. Alternatively or additionally, to learn long-term effects, the application quality is comparable to the wear pattern. For example, it can then be determined whether a tolerance specification was inadequate or whether a tolerance limit even represents oversizing. In an embodiment, it is determined (especially with a legally prescribed maximum service life) whether at least part of the refinement layer is still sufficiently intact and can be reused. In an embodiment, a removed portion of material from the support body is reapplied at least to a necessary extent using an application method. This creates a new treatment surface, at least in places.

Followed by step ii., in step iii. the worn refinement layer (that is at least the worn portion or in total) is removed so that the treatment surface of the workpiece is exposed. The treatment surface is prepared during the removal or afterwards, but still in step iii., in such a way that the treatment surface is receptive to receive a (new) refinement layer. It should be noted that the treatment surface is not necessarily the same or of the same type as that of a new (uncoated) support body. Rather, for example, part of the old refinement layer is still preserved or, on the contrary, a layer of the material of the support body is removed and a new treatment surface is thus formed.

In an embodiment, the worn refinement layer is removed using an etching process in such a way that the worn refinement layer is removed from the workpiece and at the same time the treatment surface has a predetermined surface quality or roughness.

In a preferred embodiment, the worn refinement layer is removed using compressed air blasting, particularly preferably using carbide blasting, and most preferably the treatment surface is prepared at the same time.

In both embodiments, the worn refinement layer is removed in such a way that no or only a very small proportion of the support body is removed from the workpiece, so that after the refinement layer has been removed, the workpiece or its support body is free of the worn refinement layer. It should be noted that in both embodiments the treatment surface is prepared again by means of the removal methods used, simultaneously or following the removal, in such a way that a new application of a (new) refinement layer can be carried out. The removal is carried out using the reference mark and referencing in such a targeted manner that material is only removed minimally or not at all from the support body.

In step iv., a new refinement layer is applied to the prepared treatment surface of the workpiece, wherein the refinement layer is applied referenced to the detected reference mark. In an embodiment, the refinement layer is applied using a conventional application method, wherein the reference mark for referencing with the tool chuck in step ii. is carried out in such a way that the (new) refinement layer is applied with high precision.

In a preferred embodiment, the (new) refinement layer is carried out using a coating method according to the description above. It should be noted that here too the reference mark detected in step ii. is used with the tool chuck for referencing. This also results in a highly precise application with of the refinement layer to the treatment surface.

It is further proposed in an advantageous embodiment of the reprocessing method that in a step v. before step iii., the condition of the worn refinement layer is detected, referenced to the reference mark, which in a measuring-in method according to an embodiment according to the above description before or at the time of production the now worn refinement layer is created.

It is now proposed here that in step v., which is carried out before step iii. of the reprocessing method, the condition of the worn refinement layer is detected. For example, due to uneven mechanical and/or thermal loads, the refinement layer is removed differently in different regions, so that during removal in step iii. of the reprocessing method, some process parameters, for example the processing time and/or the irradiation angle, are varied.

Therefore, in step v., the condition of the refinement layer is detected using the reference mark and the removal in step iii. is adjusted accordingly. The reference mark was created in a measuring-in method before or at the time of creation of the now worn refinement layer, so that the condition of the refinement layer is determined by referencing the reference mark.

In an embodiment, the reference mark is applied to the refinement layer, so that the wear in step v. is determined using the height difference between the tool chuck and the reference mark.

In an alternative embodiment, the wear of the refinement layer is determined based on the depth of the reference mark, so that if the target layer thickness of the refinement layer is known, the processing time for removal is determined in step v.

It is further proposed in an advantageous embodiment of the reprocessing method that the refinement layer is formed by means of extremely high-speed laser deposition welding.

In order to carry out the application of the refinement layer to the workpiece in step iv. of the reprocessing method, it is proposed here that the application is carried out using extremely high-speed laser deposition welding. In extremely high-speed laser deposition welding, a surface application or refinement layer is created by melting and simultaneously applying almost any material, wherein the heat source for melting is a high-power laser.

In an embodiment, the refinement layer of metallic powder and/or hard materials, for example ceramic powder materials, is applied to the treatment surface by means of extremely high-speed laser deposition welding and firmly bonded or bonded to the support body.

It should be noted that extremely high-speed laser deposition welding in step iv. represents an advantageous embodiment and does not require any further method.

The invention described above is explained in detail below against the relevant technical background with reference to the associated drawings, which show preferred embodiments. The invention is in no way limited by the purely schematic drawings, wherein it should be noted that the drawings are not true to size and are not suitable for defining size relationships. It is shown in

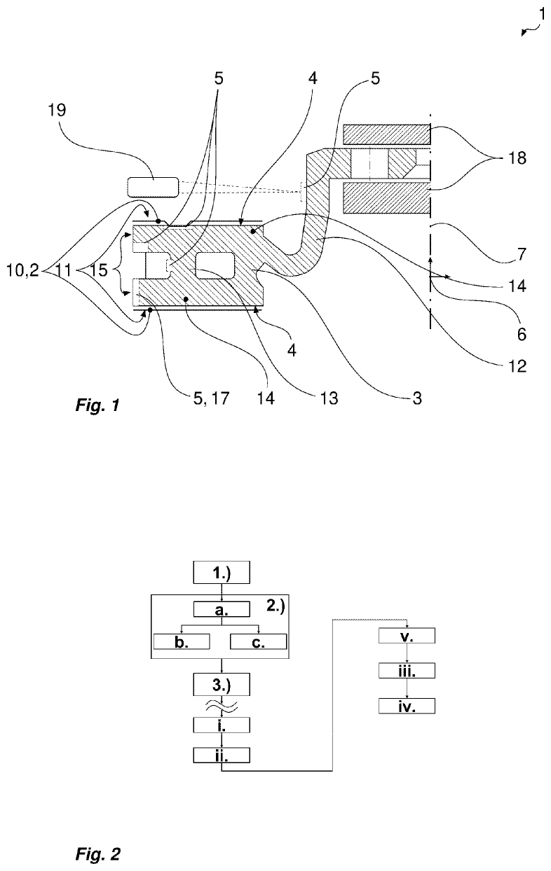

FIG. 1: a workpiece in an embodiment as a brake disc;

FIG. 2: a flowchart of a reprocessing method; and

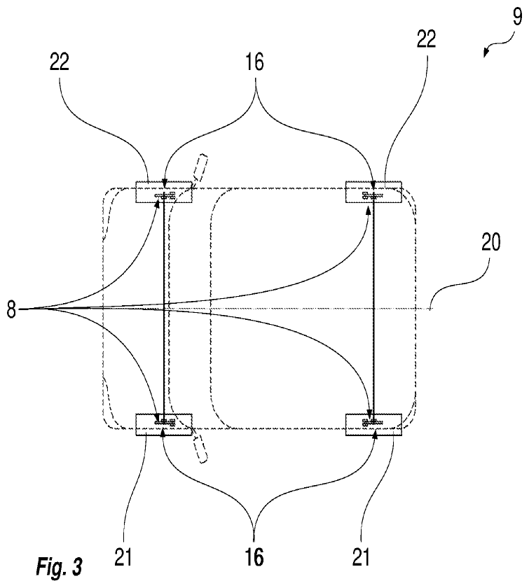

FIG. 3: a motor vehicle with brake discs.

In FIG. 1 a workpiece 1 is shown in an embodiment as a brake disc 8 in a sectional view. The workpiece 1 is arranged rotationally symmetrically about an axis of rotation 7 and axially clamped in a tool chuck 18. The tool chuck 18 includes a stationary coordinate system 6, which is used for referencing in a measuring-in method (see FIG. 2). The brake disc 8 is designed by the tool chuck 18 in the radial direction in such a way that the clamped part of the brake disc 8 is firmly connected to a plurality (here for example two) of friction discs 14 (here offset downwards) by means of a gooseneck 12. In this embodiment, the gooseneck 12 is manufactured in one piece with the friction discs 14 and the clamped part of the brake disc 8.

The gooseneck 12 is surrounded by a support body 3 of the workpiece 1. In this embodiment, the support body 3 forms the mechanically load-bearing part of the brake disc 8, wherein the surface of the support body 3 comprises a treatment surface 4. The treatment surface 4 is set up to accommodate a refinement layer 2. For example, the treatment surface 4, in a coating method (see FIG. 2) has been firmly bonded to a refinement layer 2. In this embodiment, the coating layer 2 is designed in such a way that it forms a hard material layer 10 and thus defines a friction surface 11 of the brake disc 8. The brake disc 8 is bounded radially on the outside by an outer edge 15. The friction surfaces 11 are designed to absorb the torque of a deceleration process by means of a brake pad. During deceleration, a large amount of heat is generated in a short time due to the conversion of kinetic energy into thermal energy. The refinement layer 2 is designed in such a way that abrasion is reduced due to the mechanical load.

In this embodiment, the brake disc 8 is internally cooled, so that the two friction discs 14 are arranged parallel along the axis of rotation 7 and are firmly connected by means of ventilation ribs 13. The ventilation ribs 13 are designed to remove the heat generated during the deceleration process.

In this embodiment example, the workpiece 1 comprises a plurality of reference marks 5, wherein one reference mark 5 is arranged on the gooseneck 12. A further reference mark 5 is recessed into the refinement layer 2 so that the reference mark 5 is arranged below the refinement layer 2 in the substrate 3, wherein the refinement layer 2 at least partially covers the reference mark 5. A further reference mark 5 is arranged on the outer edge 15 and on a ventilation rib 13. In this design example, a further reference mark 5 is designed as a balancing mark 17 and is arranged outside the friction surfaces 11 on the outer edge 15.

In this example, a measurement unit 19 is arranged outside the brake disc 8 in such a way that it is set up to detect the reference mark 5 on the gooseneck 12 of the brake disc 8.

In FIG. 2, a flow diagram of a reprocessing method is shown. The reprocessing method is preceded by a coating method with a measuring-in method, so that these two methods are also described here. Reference is made to the workpiece 1 in FIG. 1 without exclusion of the general description and in this respect reference is made to the description there.

In step 1.) of the coating method, the workpiece 1 is clamped in a tool chuck 18 in such a way that the treatment surface 4 of the workpiece 1 is coated with a refinement layer 2 in a subsequent step.

In step 2.), the measuring-in method can be carried out in addition to the coating method, so that in this embodiment example, step a. of the measuring-in method is carried out at the same time as step 2.) of the coating method. In step a. of the measuring-in method, the workpiece 1 is clamped in a tool chuck 18 or is already clamped in the tool chuck 18 in step 1.).

After step a., the reference mark 5 is detected in step b. In an embodiment, the reference mark 5 has already been imprinted into the workpiece 1 in a previous step b1. and is now detected in step b2.

It should be noted that the reference mark 5 is set in reference to the tool chuck 18 in both embodiments, wherein the tool chuck 18 comprises an external (machine) coordinate system 6. By means of the tool chuck 18 and the reference mark 5 arranged in relation to it, repeatable referencing of the workpiece 1 on a measurement unit 19 is therefore possible.

After step a., in step c., the workpiece 1 is measured using a measurement unit 19. The reference mark 5 is used as a reference so that the workpiece 1 is referenceable to a stationary highly precise coordinate system 6 for measuring. In an embodiment, the reference mark 5 is used as the starting point for measuring using the measurement unit 19. It should be noted that the order of steps b. and c. are interchangeable at will.

In a subsequent step 3.), a refinement layer 2 is applied to the treatment surface 4 of the workpiece 1 or the support body 3, wherein the application is referenced to the reference mark 5. Due to the referencing by means of the reference mark 5, which was detected in step 2.), and the tool chuck 18, the application takes place in a repeatable predetermined geometry, so that the refinement layer 2 is applied to the treatment surface 4 in a precisely controlled manner in step 3.).

The workpiece 1 is now ready for operation after step 3.) of the coating process. During operation, the workpiece 1 undergoes wear of the refinement layer 2, so that it undergoes a reprocessing process at a subsequent but later point in time (at the end of the service life of the workpiece 1).

In step i. of the reconditioning process, the workpiece 1 is again clamped in the tool chuck 18, wherein the workpiece 1 comprises a now worn refinement layer 2.

In a subsequent step ii., the reference mark 5, which was created before or at the time of creation of the now worn refinement layer 2, is detected and referenced to the tool chuck 18.

It is now proposed here that in step v., which is carried out before step iii. is carried out, the condition of the worn refinement layer 2 is detected. For example, due to uneven mechanical and/or thermal loads, the refinement layer 2 is removed differently in different regions, so that during removal in step iii. some process parameters are varied of the reprocessing method. Therefore, the state of the refinement layer 2 is detected in step v. using the reference mark 5 and the removal is carried out in step iii. is adjusted accordingly.

Following step v., in step iii. the worn refinement layer 2 is removed so that the treatment surface 4 of the workpiece 1 is exposed. The treatment surface 4 is prepared during the removal or afterwards, but still in step iii., in such a way that the treatment surface 4 is receptive for receiving a (new) refinement layer 2. The worn coating layer 2 is removed by means of the reference mark 5 and referencing in such a targeted manner that the support body 3 is removed only minimally or not at all.

In step iv., a new refinement layer 2 is applied to the prepared treatment surface 4 of the workpiece 1, wherein the application of the refinement layer 2 is referenced to the detected reference mark 5. It should be noted that the application of the refinement layer 2 is preferably carried out according to the coating process described above.

In FIG. 3, a motor vehicle 9 with brake discs 8 as shown in FIG. 1 is shown in a schematic top view. The motor vehicle 9 has a longitudinal axle 20 and propulsion wheels 21, 22 set up for propulsion. The left drive wheel 21 and the right drive wheel 22 are set up to transmit torque to the ground and are connected to the motor vehicle 9 via a wheel hub 16. The brake discs 8 are designed to decelerate the propulsion, that is to absorb the torque of the propulsion wheels 21, 22. The brake discs 8 are firmly connected to the wheel hubs 16 and arranged between the drive wheels 21, 22 and the wheel hub 16. Each brake disc 8 is designed to convert kinetic energy into thermal energy. The coating layer 2 reduces the abrasion of the brake discs 8 during deceleration and/or provides corrosion protection.

With the workpiece proposed here and the associated reference mark, a high-precision application and reprocessing of a refinement layer on the workpiece can be carried out.

### LIST OF REFERENCE NUMERALS

1 Workpiece
2 Refinement layer
3 Support body
4 Treatment surface
5 Reference mark
6 Coordinate system
7 Axis of rotation
8 Brake disc
9 Motor vehicle
10 Hard material layer
11 Friction surface
12 Gooseneck
13 Ventilation rib
14 Friction discs
15 Outer edge
16 Wheel hub
17 Balancing mark
18 Tool chuck
19 Measurement unit
20 Longitudinal axle
21 Left drive wheel
22 Right drive wheel

1-10 (canceled)

11. Workpiece to be coated with a refinement layer, wherein the workpiece has a support body with a treatment surface, wherein the refinement layer is applicable or is applied to the treatment surface (4),
wherein,
on the workpiece a reference mark is provided to which a stationary coordinate system that is highly precise relative to the workpiece is repeatably assignable.

12. Workpiece (1) according to claim 11, wherein the workpiece is a rotary workpiece with an axis of rotation, preferably a brake disc for a motor vehicle.

13. Workpiece according to claim 11, wherein the refinement layer is a hard material layer for a friction surface of the workpiece.

14. Workpiece according to claim 11, wherein the reference mark is retained over an intended service life of the workpiece,
wherein preferably the reference mark is still retained when the workpiece or the refinement layer is reprocessed.

15. Workpiece according to claim 11, wherein the workpiece is a brake disc and the reference mark is arranged on at least one of the following sections of the brake disc:
in the region of the gooseneck;
in the region of the ventilation ribs between the two friction discs of the brake disc in an internally cooled embodiment, preferably radially on the outside;
on the outer edge of the brake disc;
on the wheel hub radially outside or radially inside on the shell side, axially inside or axially outside on the face side;
in the treatment surface; and
in one or as one balancing mark.

16. Measuring-in method for a workpiece, having the following steps:
a. Clamping in a tool chuck, a workpiece with a treatment surface for coating with a refinement layer;
b. Imprinting into the workpiece and detecting a reference mark and referencing the reference mark to the tool chuck; and
c. after step a., by means of a measurement unit, measuring the workpiece referenced to the reference mark.

17. Coating method for a workpiece according to claim 11, having the following steps in said order:
1.) Clamping in a tool chuck, a workpiece with a treatment surface for coating with a refinement layer;
2.) Detecting the reference mark, wherein preferably the reference mark is generated in said measuring-in method, and referencing the reference mark to the tool chuck; and
3.) Application of a refinement layer on the treatment surface of the workpiece referenced to the reference mark detected in step 2.), wherein preferably the reference mark is permanently detected during step 3.) and a change in position of the reference mark relative to the tool chuck is monitored.

18. Reprocessing method for a workpiece with a worn refinement layer according to claim 11, having the following steps in said order:
i. Clamping of a workpiece with a worn refinement layer in a tool chuck, wherein preferably the now worn refinement layer has been produced by means of said coating process;
ii. Detecting the reference mark, wherein preferably the reference mark is generated in said measuring-in method before or at the time of generation of the now worn refinement layer, and referencing the reference mark to the tool chuck; and
iii. Removal of the worn refinement layer and preparation of the treatment surface;
iv. Application of a new refinement layer on, as prepared in step iii., the treatment surface of the workpiece, referenced to the reference mark detected in step ii.

19. Reprocessing method according to claim 18, wherein in a step v. before step iii. the state of the worn refinement layer is detected, referenced to that reference mark which is generated in said measuring-in method before or at the time of generation of the now worn refinement layer.

20. Reprocessing method according to claim 18, wherein the refinement layer is formed by means of extremely high-speed laser deposition welding.
